(19) United States
(12) Patent Application Publication
(10) Pub. No.: US 2024/0186532 A1
(43) Pub. Date: Jun. 6, 2024

(54) FUEL CELL ELECTRODE WITH HIGH GAS PERMEABILITY, METHOD OF MANUFACTURING SAME, AND MEMBRANE-ELECTRODE ASSEMBLY INCLUDING SAME

(71) Applicants: Hyundai Motor Company, Seoul (KR); Kia Corporation, Seoul (KR)

(72) Inventors: Seong Jun Jo, Yongin-si (KR); II Seok Chae, Seoul (KR)

(21) Appl. No.: 18/314,972

(22) Filed: May 10, 2023

(30) Foreign Application Priority Data
Nov. 15, 2022 (KR) 10-2022-0152166

(51) Int. Cl. H01M 4/86; H01M 4/88; H01M 8/1004

(52) U.S. Cl. CPC H01M 4/8668; H01M 4/8605; H01M 4/8828; H01M 8/1004; H01M 2008/1095

(57) ABSTRACT

Proposed is an electrode enabling a fuel cell with high performance due to superior gas permeability to Nafion, which is a conventionally available binder. The electrode can be manufactured at low costs by minimizing the usage of expensive platinum catalyst. In addition, a polymer with high gas permeability can be obtained in a high yield through click reaction-based modification. Furthermore, the electrode can be optimized and bonded to various electrolyte membranes due to various physical properties obtained by adjusting the molecular weight of additive materials.

### CROSS REFERENCE TO RELATED APPLICATIONS

The present application claims priority to Korean Patent Application No. 10-2022-0152166, filed Nov. 15, 2022, the entire contents of which is incorporated herein for all purposes by this reference.

### TECHNICAL FIELD

The present disclosure relates to a fuel cell electrode with high gas permeability, a method of manufacturing the same, and a membrane-electrode assembly including the same.

### BACKGROUND

A membrane-electrode assembly (MEA), which is the core component of a proton exchange membrane fuel cell (PEMFC), is composed of an ionomer electrolyte membrane allowing hydrogen ions to pass therethrough and two electrode catalyst layers provided on respective sides of the membrane and made of a mixture of an electrode catalyst and an ionomer binder. In electrode catalyst layers, ionomer binders with low gas permeability are the major factors that cause battery performance deterioration, unlike electrolyte membranes requiring low gas permeability. When ionomer binders with high gas permeability are used, high reaction activity can be maintained even with the low amount of expensive platinum catalyst, and fuel cell performance equivalent to or higher than that with the large amount of expensive platinum catalyst can be exhibited. However, as a commercialized electrode binder, Nafion, which has a limit of low oxygen gas permeability, has been used.

Research has been variously conducted on controlling gas permeability in polymer membranes, including the addition of porous nanomaterials such as zeolites and metal organic frameworks (MOF), which are the combinations of inorganic materials. Particularly, an increase in free volume based on inherent properties of polymer main chains enables additional modifications and is thus highly likely to be applied to various fields. Typically, polymers with high free volume are referred to as polymers of intrinsic microporosity (PIMs).

As described in a non-patent document (Journal of Membrane Science 2021, 635, 119440), gas permeability has been successfully controlled by introducing a sulfonic acid group of PIM ionomer thin film into a benzene structure. However, since the membrane has been modified in the thin film, not in a non-volatile phase, dimensional stability and gas permeability have been rather insufficient. In addition, the electrochemical evaluation of the modified membrane has not been conducted.

### SUMMARY

An objective of the present disclosure is to provide a fuel cell electrode including a hydrocarbon-based binder with high gas permeability obtained through an additional modification of a structure of a polymer of intrinsic microporosity (PIM), which can be obtained in a high yield without additional reaction, a method of manufacturing the same, and a membrane-electrode assembly including the same.

The present disclosure has been made to provide solutions to the above problems, and another objective of the present disclosure is to provide a fuel cell electrode with high gas permeability, a method of manufacturing the same, and a membrane-electrode assembly including the same.

Objectives of the present disclosure are not limited to the objectives mentioned above. The above and other objectives of the present disclosure will become more apparent from the following description, and will be realized by the means of the appended claims, and combinations thereof.

According to one embodiment of the present disclosure, a fuel cell electrode includes catalyst particles and a binder in which the catalyst particles are dispersed. The binder includes a polymer of intrinsic microporosity (PIM) and at least one substituent containing a sulfonic acid group (—SO₃H).

The polymer of intrinsic microporosity may be represented by Formula 1:

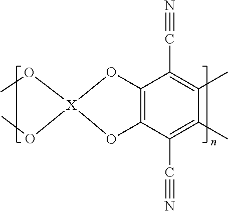

Wherein X includes at least one selected from the group consisting of

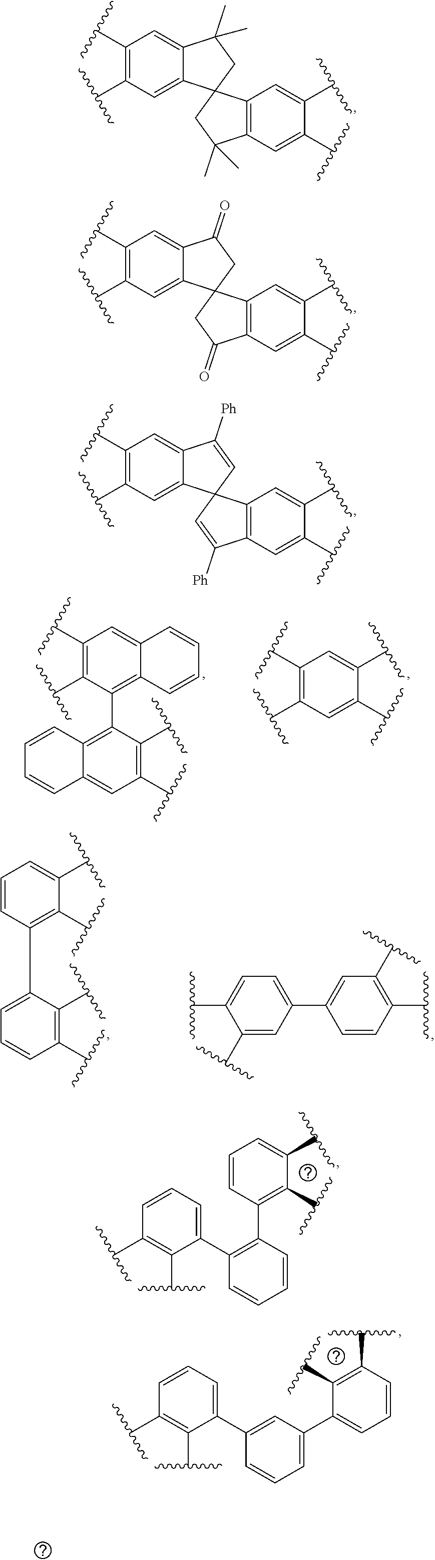

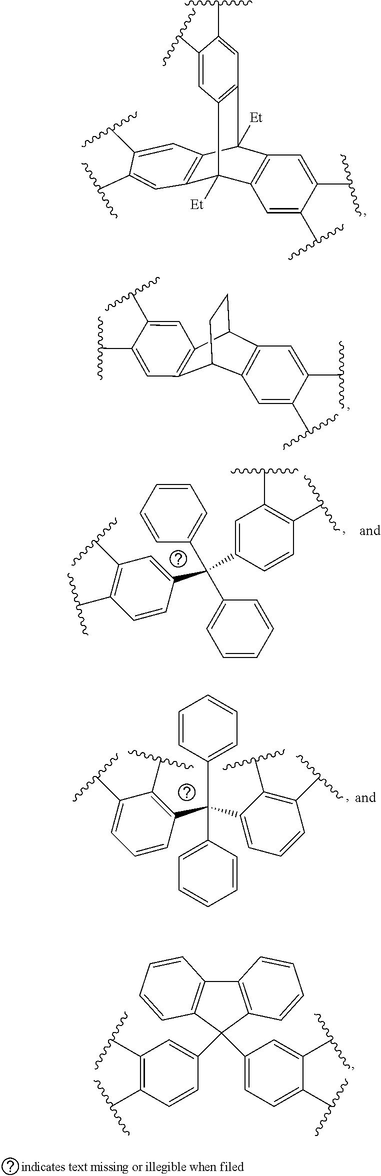

and n is an integer in a range of 10 to 400.

The sulfonic acid group may include at least one selected from the group consisting of

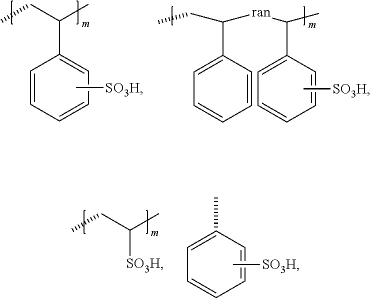

and combinations thereof, wherein m is an interger in a range of 1 to 48. A molar ratio of polystyrene ((C₈H₈)ₙ) to the sulfonic acid group (—SO₃H) contained in the

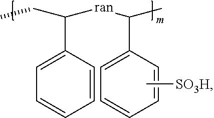

may be in a range of 1:0.2 to 0.8.

The substituent may have a number average molecular weight (Mn) in a range of 108 g/mol to 5,000 g/mol.

The substituent may have a molecular weight distribution (MWD) in a range of 1.05 to 2.0.

The substituent may substitute for a cyano group of the polymer of intrinsic microporosity.

The binder may be represented by Formula 2:

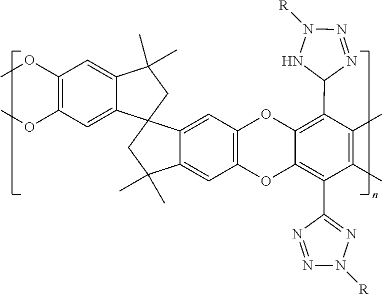

Wherein n is an integer in a range of 10 to 400, R includes at least one selected from the group consisting of

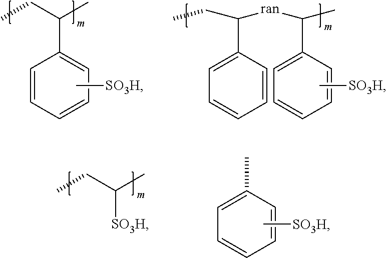

and combinations thereof, and m is an integer in a range of 1 to 48.

According to one embodiment of the present disclosure, a method of manufacturing a fuel cell electrode includes: preparing a polymer of intrinsic microporosity (PIM); preparing a binder by substituting a substituent containing a sulfonic acid group into the polymer of intrinsic microporosity; preparing a slurry by adding catalyst particles to the binder; and forming an electrode by applying the slurry on a substrate.

The binder may be prepared by introducing the polymer of intrinsic microporosity, an azide group (R—N₃), and zink chloride (ZnCl₂) into n-methyl-2-pyrrolidone (NMP) and by stirring the resultant product

The binder may be produced through a click reaction between a cyanide (—CN) of the polymer of intrinsic microporosity and an azide group (—N₃).

In the slurry preparation, a solvent may include at least one selected from the group consisting of methanol, ethylol, isopropanol, n-propyl alcohol, acetone, ultrapure water, and combinations thereof

A weight ratio of the solvent to the binder and the catalyst may be in a range of 1:0.02 to 0.3.

A weight ratio of the binder to the catalyst contained in the slurry may be in a range of 1:0.5 to 2.0.

According to one embodiment of the present disclosure, a membrane-electrode assembly includes: an electrolyte membrane; a cathode formed on a first surface of the electrolyte membrane; and an anode formed on a second surface of the electrolyte membrane, in which at least one of the cathode and the anode includes the above-mentioned electrode.

In the present disclosure, an electrode enables a fuel cell with high performance due to superior gas permeability to Nafion, which is a conventionally available binder. The electrode can be manufactured at low costs by minimizing the usage of expansive platinum catalyst. In addition, a polymer with high gas permeability can be obtained in a high yield through click reaction-based modification. Furthermore, the electrode can be optimized and bonded to various electrolyte membranes due to various physical properties obtained by adjusting the molecular weight of additive materials.

Effects of the present disclosure are not limited to the effects mentioned above. It should be understood that the effects of the present disclosure include all effects which can be deduced from the following description.

### BRIEF DESCRIPTION OF THE DRAWINGS

FIG. 1 is a schematic flow chart illustrating a method of manufacturing a fuel cell electrode according to one embodiment of the present disclosure; and

FIG. 2 is a diagram illustrating a membrane-electrode assembly.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. The singular expression includes the plural expression unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

According to one embodiment of the present disclosure, a fuel cell electrode includes catalyst particles and a binder in which the catalyst particles are dispersed.

The catalyst particles may include catalyst metal supported on a carrier.

The catalyst metal may include at least one selected from the group consisting of platinum, palladium, cobalt, gold, ruthenium, tin, molybdenum, palladium, rhodium, iridium, bismuth, copper, yttrium, and chromium. Preferably, the catalyst metal includes platinum and an alloy of platinum.

The carrier may include a carbon-based carrier. The carbon-based carrier may include at least one selected from the group consisting of graphite, carbon black, acetylene black, Denka black, Ketjen black, activated carbon, mesoporous carbon, carbon nanotubes, carbon nanofibers, carbon nanohorns, carbon nanorings, carbon nanowires, fullerene (C60), and super P.

The binder includes a polymer of intrinsic microporosity (PIM).

Even though Nafion is mainly used as a currently available binder, there is a limitation in that Nafion has low oxygen gas permeability. To solve the problem, the present disclosure uses the polymer of intrinsic microporosity, a polymer typically known to have high free volume, so that an increase in free volume obtained by using the intrinsic properties of polymer main chains can enable additional modifications.

The polymer of intrinsic microporosity may be represented by Formula 1.

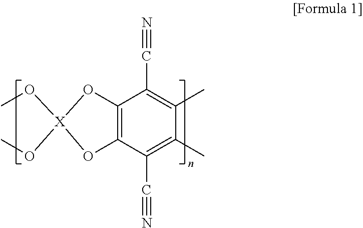

In Formula 1, X includes at least one selected from the group consisting of

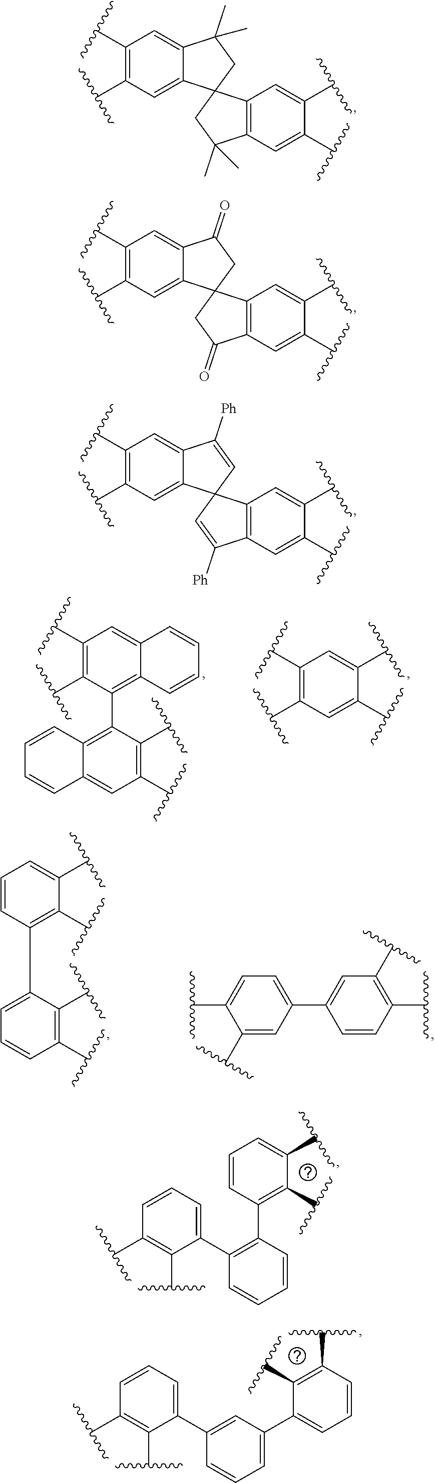

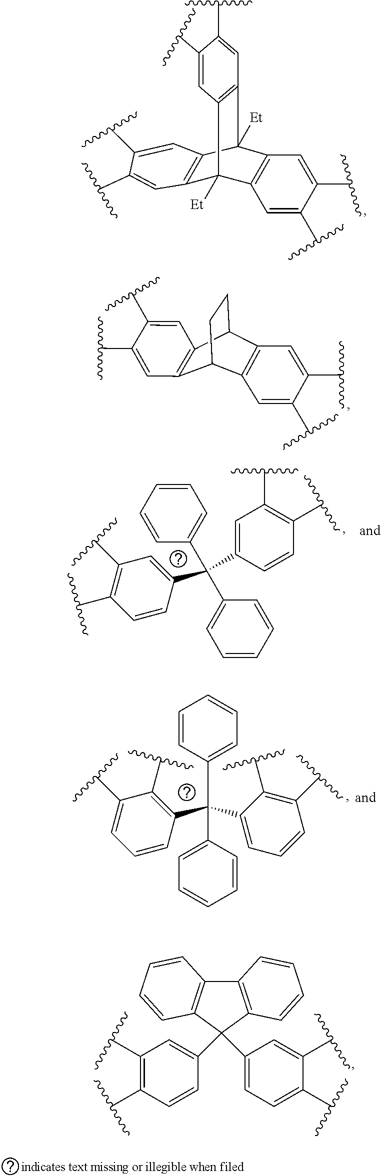

and n is an integer in a range of 1 to 400.

The binder may allow hydrogen ions to move and may control gas permeability by introducing a sulfonic acid group as a substituent into the polymer of intrinsic microporosity through substitution.

The sulfonic acid group may include at least one selected from the group consisting of

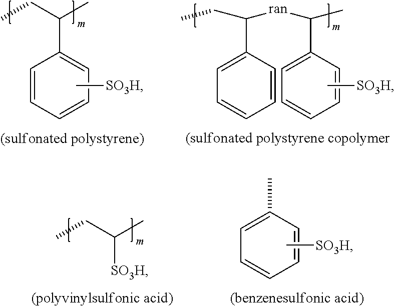

and combinations thereof, and m is an integer in a range of 1 to 48.

A molar ratio of polystyrene ((C₈H₈)ₙ) to the sulfonic acid group (—SO₃H) contained in the

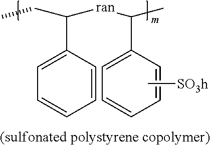

may be in a range of 1:0.2 to 0.8.

The substituent may have a number average molecular weight (Mn) in a range of 108 g/mol to 5,000 g/mol. When the number average molecular weight is less than 108 g/mol, there may be a problem in that proton conductivity is rapidly reduced. When the number average molecular weight exceeds 5,000 g/mol, there may be a problem in that a glass transition temperature rapidly decreases, thereby deteriorating mechanical properties at a temperature in a range of 25° C. to 90° C.

The substituent may have a molecular weight distribution (MWD) in a range of 1.05 to 2.0.

In the related art, gas permeability has been successfully controlled by introducing a sulfonic acid group into a benzene structure of a PIM ionomer thin film. However, since modification has been performed on the thin film, not in a non-volatile phase, dimensional stability and gas permeability have been rather insufficient. When introducing the sulfonic acid group into the benzene structure, there is a problem in that additional reactions cause hydrolysis and oxidation of the PIM structure, resulting in a decrease in molecular weight and deterioration of physical properties.

Hence, to solve the problem, the sulfonic acid group of the present disclosure may substitute for a cyano group in the polymer of intrinsic microporosity.

The binder may be represented by Formula 2.

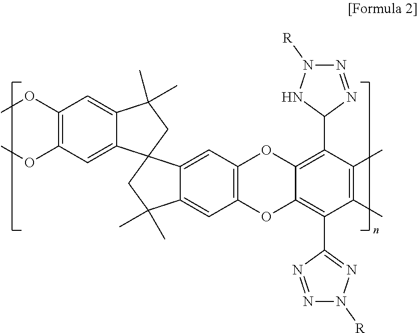

In Formula 2, n is an integer in a range of 1 to 400, R includes at least one selected from the group consisting of

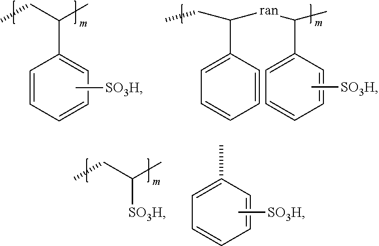

and combinations thereof, and m is an integer in a range of 1 to 48.

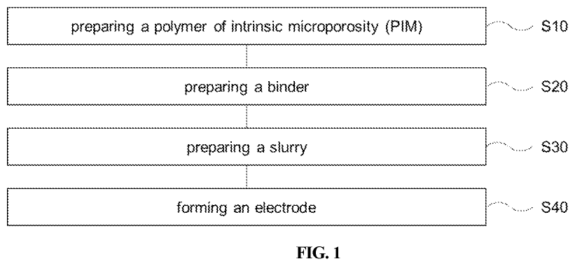

FIG. 1 is a schematic flow chart illustrating a method of manufacturing a fuel cell electrode according to one embodiment of the present disclosure. Referring to FIG. 1, the method includes preparing a polymer of intrinsic microporosity (PIM)(S 10), preparing a binder by introducing a substituent including a sulfonic acid group into the polymer of intrinsic microporosity through substitution(S20), preparing a slurry by adding catalyst particles to the prepared binder(S30), and forming an electrode by applying the slurry on a substrate(S40).

In S10, the polymer of intrinsic microporosity may be manufactured through a condensation reaction between a monomer A represented by Formula 3 and a monomer B represented by Formula 4.

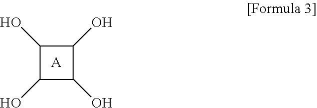

In Formula 3, A may include at least one selected from the group consisting of

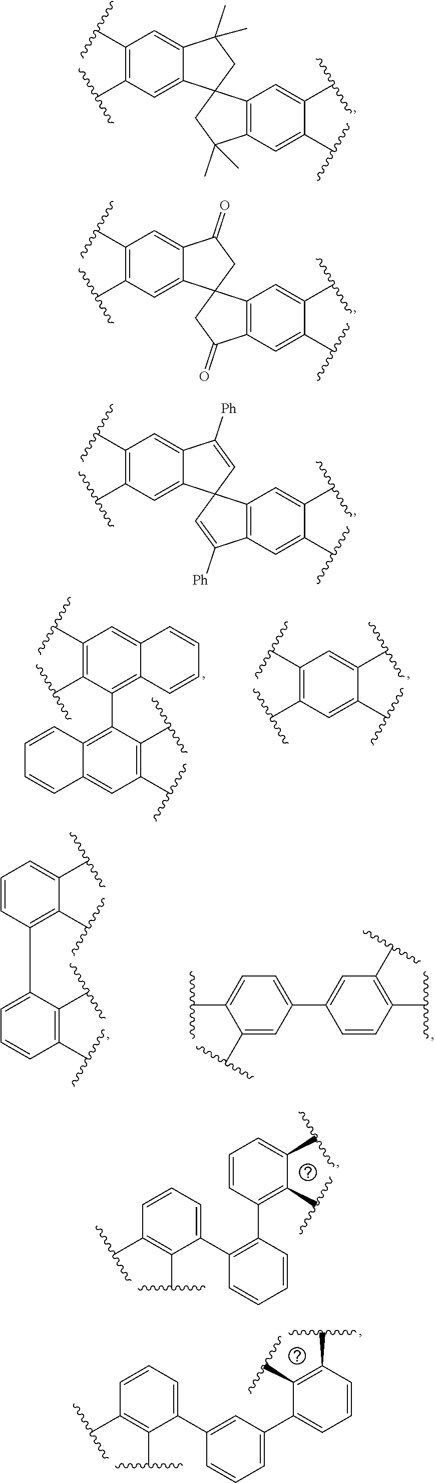

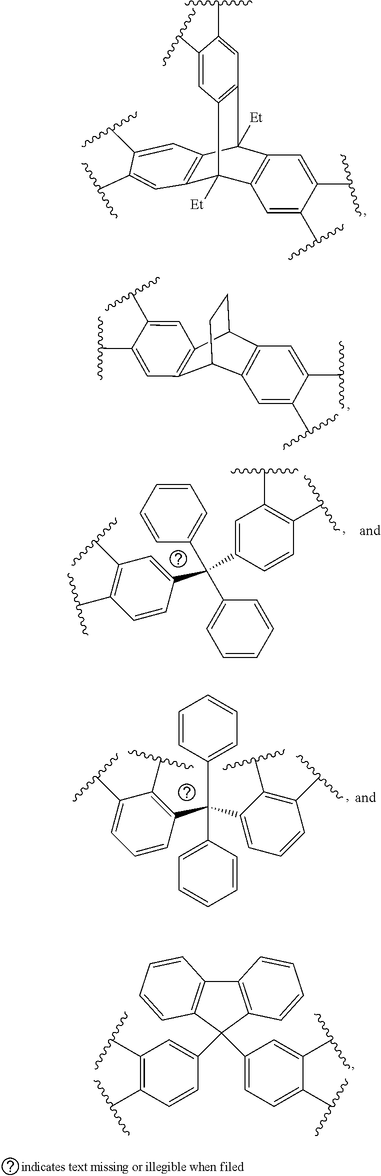

The monober B may be represented by Formula 4.

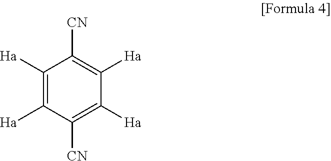

Ha may include at least one halogen element selected from the group consisting of F, Cl, Br, and I.

The condensation reaction between the monomers A and B may be performed in a conventionally known manner, and is not particularly limited.

In S10, the polymer of intrinsic microporosity may be obtained by introducing 5,5′,6,6′-tetrahydroxy-3,3,3′,3′-tetramethylspirobisindane (TTSBI), 2,3,5,6-tetrafluoroterephthalonitrile (TFTPN), and potassium carbonate (K₂CO₃) into dimethylformamide (DMF) and by stirring the resultant product. For example, the polymer of intrinsic microporosity may be prepared through the following reaction formula.

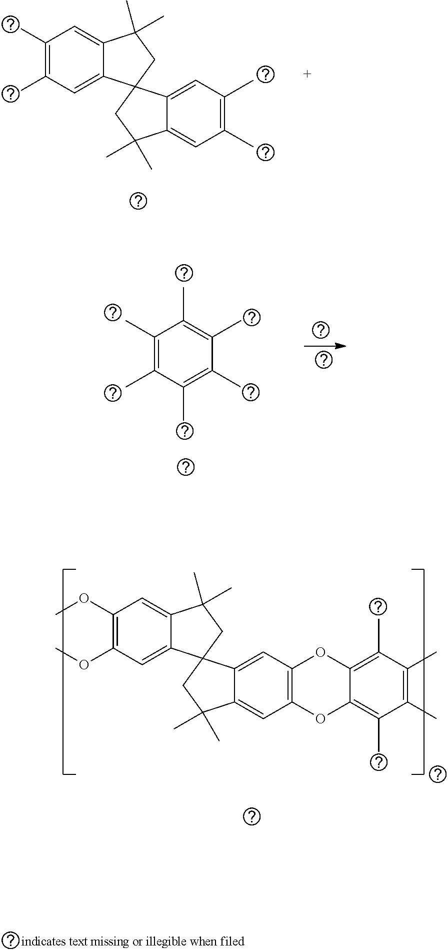

For example, based on 1 mmol of TTSBI (0.34 g), 0.2 mmol to 5 mmol of TFTPN (0.04 g to 1 g), 1 mmol to 9 mmol of K 2 CO 3 (0.13 g to 1.2 g), and 2 mL to 20 mL of DMF are added to a 100 mL of round-bottom flask. Then, the flask is filled with nitrogen gas or argon after being connected to a reflux condenser, and the resulting mixture is stirred and heated at a temperature in a range of 140° C. to 180° C. for 0.5 hours to 8 hours. The temperature is cooled to 25° C. after the reaction is completed, and the resulting reaction product is precipitated in an organic solvent including methanol or ethanol. Using the same solvent, the precipitated product is reprecipitated one to three times and then dried in a vacuum oven at a temperature in a range of 60° C. to 100° C. for 20 to 28 hours to obtain the polymer of intrinsic microporosity.

In S20, the binder may be obtained by putting the polymer of intrinsic microporosity, an azide group (R—N₃), and zinc chloride (ZnCl₂) into n-methyl-2-pyrrolidone (NMP) and stirring the resultant product.

Specifically, the binder may be involved in a reaction for connecting R group by forming tetrazole through a click reaction between a cyanide (—CN) of the polymer of the intrinsic microporosity and an azide (—N₃) of the azide group. For example, the binder may be obtained by the following reaction formula.

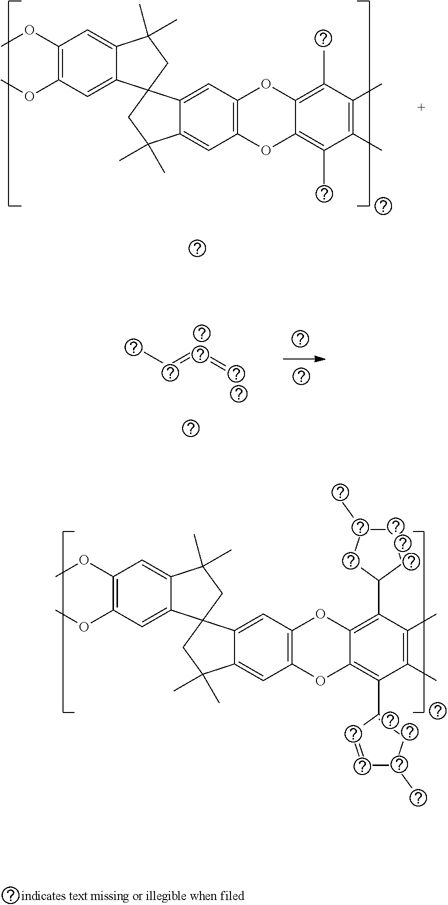

For example, based on 1 mmol of the PIM-1 prepared in S10, 0.1 mmol to 0.8 mmol of an azide group, 0.05 mol to 0.4 mmol of zinc chloride (ZnCl₂), and 2 mL to 20 mL of n-methyl-2-pyrrolidone (NMP) are added to a 100 mL of round-bottom flask. Then, the flask is filled with nitrogen gas or argon after being connected to a reflux condenser, and the resulting mixture is stirred and heated at a temperature in a range of 140° C. to 180° C. for 0.5 hours to 8 hours. The temperature is cooled to 25° C. after the reaction is completed, and the resulting reaction product is precipitated in water. Using the same solvent, the precipitated product is reprecipitated one to three times and then dried in a vacuum oven at a temperature of 80° C. for 20 hours to 28 hours to obtain the binder.

S30 may be performed in a conventionally known manner, and is not particularly limited.

In S30, a solvent may include at least one selected from the group consisting of methanol, ethylol, isopropanol, n-propyl alcohol, acetone, ultrapure water, and combinations thereof. Preferably, the solvent includes n-propyl alcohol and ultrapure water.

A weight ratio of the solvent to the binder and the catalyst may be in a range of 1:0.02 to 0.3.

A weight ratio of the binder to the catalyst contained in the slurry may be in a range of 1:0.5 to 2.0. When the weight ratio does not satisfy the above numerical range, there may be problems during slit die coating, in which a film is formed, due to an increase or decrease in the viscosity of the slurry.

In S30, for example, based on 10 g of the binder prepared in S20, 10 g of Pt/C, 100 g of n-propyl alcohol, and 100 g of ultrapure water are dispersed in a homo mixer for 2 hours to 6 hours and then dried on a drying tray at a temperature in a range of 60° C. to 100° C. for 10 hours to 15 hours. The dried powder is once again added to 10% by weight of a solution of n-propyl alcohol and ultrapure water (50:50 in % by weight) and then dispersed in the homo mixer for 1 hour to 5 hours to prepare the final slurry.

In the slurry preparation, drying step and/or heat-treating step may be further included after applying the slurry on the substrate. Conditions for the drying and/or heat treatment are not particularly limited.

S40 may be performed in a conventionally known manner and is not particularly limited. That is, S40 may be appropriately performed under conditions to the extent that the electrode is not damaged.

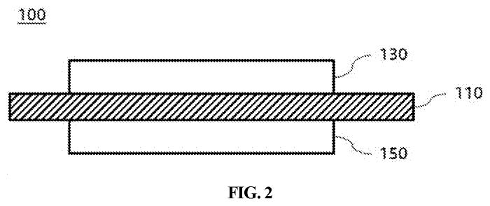

FIG. 2 is a diagram illustrating a membrane-electrode assembly. Referring to FIG. 2, the membrane-electrode assembly 100 includes an electrolyte membrane 110, a cathode 130 formed on a first surface of the electrolyte membrane 110, and an anode 150 formed on a second surface of the electrolyte membrane 110, in which at least one of the cathode 130 and the anode 150 includes the above-mentioned electrode.

In the present disclosure, an electrode enables a fuel cell with high performance due to superior gas permeability to Nation, which is a conventionally available binder. The electrode can be manufactured at low costs by minimizing the usage of expensive platinum catalyst. In addition, a polymer with high gas permeability can be obtained in a high yield through click reaction-based modification. Furthermore, the electrode can be optimized and bonded to various electrolyte membranes due to various physical properties obtained by adjusting the molecular weight of additive materials.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims. Therefore, preferred embodiments of the present disclosure have been described for illustrative purposes, and should not be construed as being restrictive.

What is claimed is:

1. A fuel cell electrode comprising:
a catalyst particle; and
a binder in which the catalyst particle is dispersed,
wherein the binder comprises a polymer of intrinsic microporosity (PIM) and at least one substituent comprising a sulfonic acid group (—SO₃H).

2. The electrode of claim 1, wherein the polymer of intrinsic microporosity is represented by Formula 1: 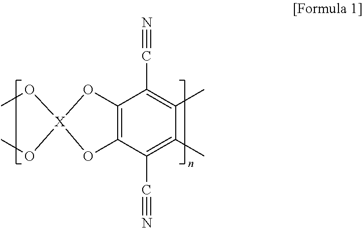
Wherein X comprises at least one selected from the group consisting of 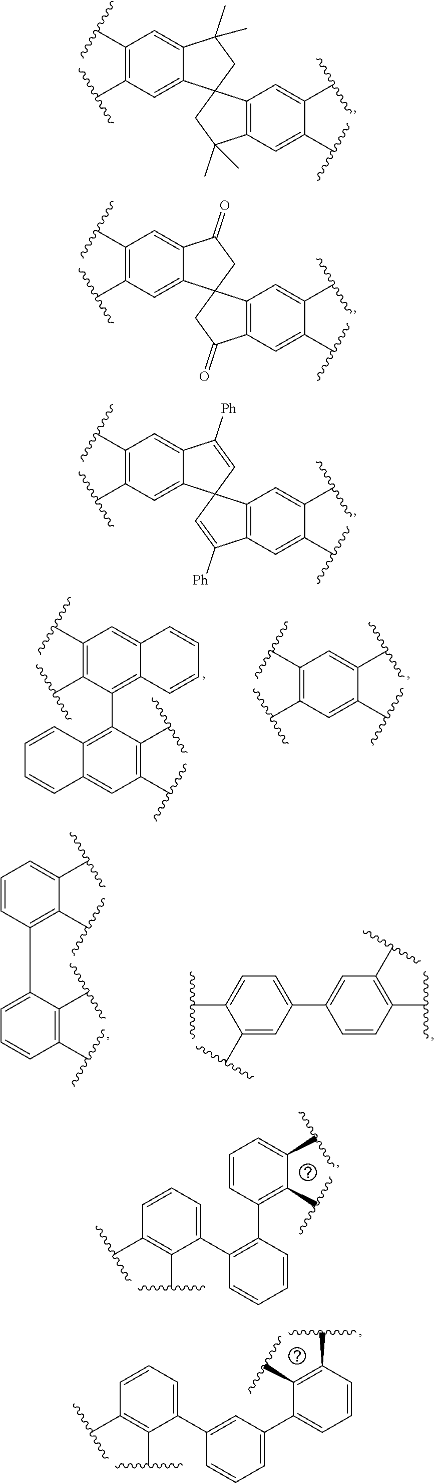 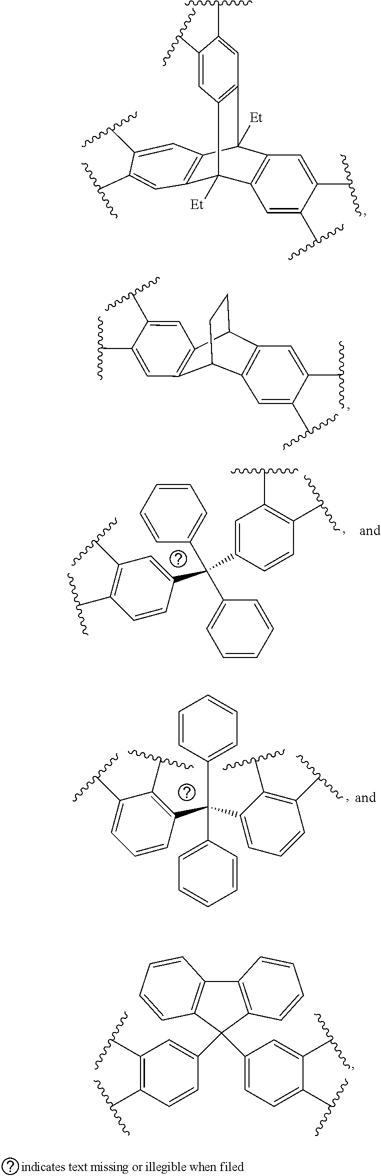
and n is an integer in a range of 1 to 400.

3. The electrode of claim 1, wherein the sulfonic acid group comprises at least one selected from the group consisting of 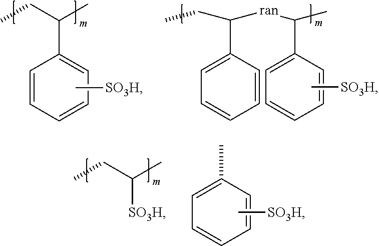
and combinations thereof, 5
wherein m is an interger in a range of 1 to 48.

4. The electrode of claim 3, wherein a molar ratio of polystyrene ((C₈H₈)ₙ) to the sulfonic acid group (—SO₃H) contained in the 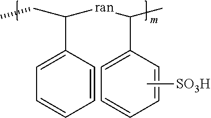
is in a range of 1:0.2 to 0.8.

5. The electrode of claim 1, wherein the substituent has a number average molecular weight (Mn) in a range of 108 g/mol to 5,000 g/mol.

6. The electrode of claim 1, wherein the substituent has a molecular weight distribution (MWD) in a range of 1.05 to 2.0.

7. The electrode of claim 1, wherein the substituent substitutes for a cyano group of the polymer of intrinsic microporosity.

8. The electrode of claim 1, wherein the binder is represented by Formula 2: 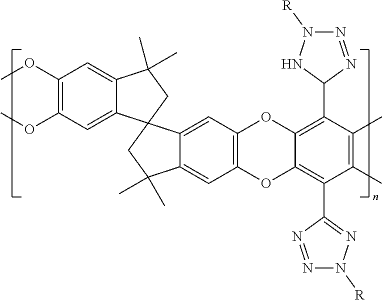
Wherein n is an integer in a range of 1 to 400, R comprises at least one selected from the group consisting of 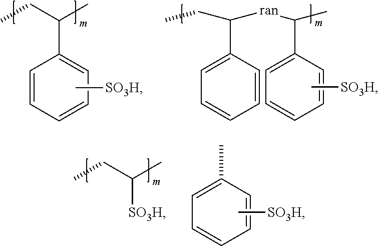
and combinations thereof, and m is an integer in a range of 1 to 48.

9. A method of manufacturing a fuel cell electrode, the method comprising:
preparing a polymer of intrinsic microporosity (PIM);
preparing a binder by substituting a substituent comprising a sulfonic acid group in the polymer of intrinsic microporosity;
preparing a slurry by adding a catalyst particle to the binder; and
forming an electrode by applying the slurry on a substrate.

10. The method of claim 9, wherein the binder is prepared by adding the polymer of intrinsic microporosity, an azide group (R—N₃), and zink chloride (ZnCl₂) into n-methyl-2-pyrrolidone (NMP) and by stirring the resultant product.

11. The method of claim 9, wherein the binder is produced through a click reaction between a cyanide (—CN) of the polymer of intrinsic microporosity and an azide group (—N₃).

12. The method of claim 9, wherein the sulfonic acid group comprises at least one selected from the group consisting of 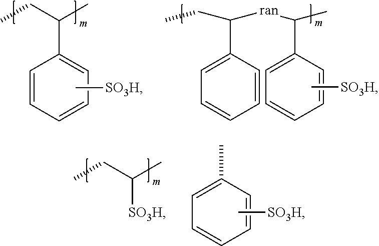
and combinations thereof,
wherein m is an interger in a range of 1 to 48.

13. The method of claim 12, wherein a molar ratio of polystyrene ((C₈H₈)ₙ) to the sulfonic acid group (—SO₃H) contained in the 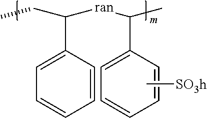
is in a range of 1:0.2 to 0.8.

14. The method of claim 9, wherein the substituent has a number average molecular weight (Mn) in a range of 108 g/mol to 5,000 g/mol and a molecular weight distribution (MWD) in a range of 1.05 to 2.0.

15. The method of claim 9, wherein the substituent is substituted for a cyano group of the polymer of intrinsic microporosity.

16. The method of claim 9, wherein the binder is represented by Formula 3: 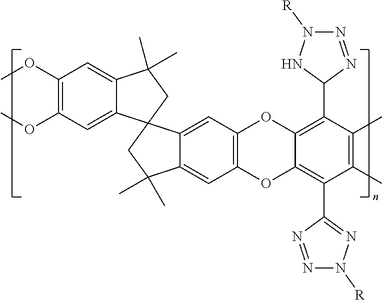
Wherein n is an integer in a range of 1 to 400, R comprises at least one selected from the group consisting of 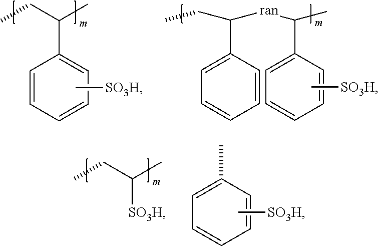
and combinations thereof, and m is an integer in a range of 1 to 48.

17. The method of claim 9, wherein preparing a slurry, a solvent comprises at least one selected from the group consisting of methanol, ethanol, isopropanol, n-propyl alcohol, acetone, ultrapure water, and combinations thereof.

18. The method of claim 17, wherein a weight ratio of the solvent to the binder and the catalyst is in a range of 1:0.02 to 0.3.

19. The method of claim 17, wherein a weight ratio of the binder to the catalyst contained in the slurry is in a range of 1:0.5 to 2.0.

20. A membrane-electrode assembly comprising:
an electrolyte membrane;
a cathode formed on a first surface of the electrolyte membrane; and
an anode formed on a second surface of the electrolyte membrane, wherein at least one of the cathode and the anode comprises the electrode of claim 1.
